(19) United States
(12) Patent Application Publication
(10) Pub. No.: US 2024/0018666 A1
(43) Pub. Date: Jan. 18, 2024

(54) A METHOD FOR PRODUCING GRAPHENE FLAKES DIRECTLY FROM MINERAL GRAPHITE

(71) Applicant: INSTYTUT NISKICH TEMPERATUR I BADAN STRUKTURALNYCH PAN IM.W.TRZEBIATOWSKIEGO, Wroclaw (PL)

(72) Inventors: Pawel GLUCHOWSKI, Wroclaw (PL); Jerzy KOWALCZYK, Wroclaw (PL); Wieslaw STREK, Bielany Wroclawskie (PL); Minh LE QUOC, Hanoi (VN); Duong Ngoc HUYEN, Hanoi (VN)

(21) Appl. No.: 18/255,162

(22) PCT Filed: Dec. 3, 2021
(86) PCT No.: PCT/PL2021/050084

§ 371 Date: May 31, 2023

(30) Foreign Application Priority Data
Dec. 21, 2020 (PL) P.436411

(51) Int. Cl. C25B 1/135; C25B 11/043; C25B 15/021; C25B 15/031; C25B 15/08

(52) U.S. Cl. CPC C25B 1/135; C25B 11/043; C25B 15/021; C25B 15/031; C25B 15/083

(57) ABSTRACT

The invention relates to a method for producing graphene flakes by electrochemical exfoliation, where electrodes (anode and cathode) together with electrolyte constitute an electrochemical circuit with current flowing through it, characterized in that the electrodes are immersed at least partially in the electrolyte and electrolysis is carried out, during which graphene flakes detach from the electrode to be released into the electrolyte solution and then the exfoliated graphene flakes are recovered from the electrolyte solution.

### TECHNICAL FIELD

The present invention relates to a method for producing graphene flakes directly from mineral graphite.

### BACKGROUND ART

Graphene is a two-dimensional (2D) one-atom-thick material consisting of carbon atoms in a honeycomb arrangement. It is distinguished by much better physical parameters than other allotropic forms of carbon in terms of its mechanical, chemical and electrical properties.

One of the first methods for obtaining graphene was mechanical exfoliation of high-quality graphite [K. S. Novoselov, A. K. Geim, S. V. Morozov, D. Jiang, Y. Zhang, S. V. Dubonos, I. V. Grigorieva and A. A. Firsov, Science 306, 666 (2004)]. Unfortunately, although the quality of such material is very good, the production technology is very expensive and inefficient. Another method for obtaining graphene is the reduction of graphene oxide (GO), which is placed in suspension, and then, by self-assembly and deposition on the surface, it forms a thin layer, which is then reduced to pure graphene. This method allows for the production of graphene layers on a large scale at relatively low costs; however, overlapping GO particles stack to form multilayer structures and degrade, and additionally some material is present in an unreduced form [D. Li, M. B. Muller, S. Gilje, R. B. Kaner and G. G. Wallace, Nat. Nanotech. 3, 101(2008)].

Still another method for obtaining graphene is to mechanically peel off (exfoliate) flakes from high-quality graphite (HOPG, Highly Oriented Pyrolytic Graphite) [M. I. Kairi, S. Dayou, N. I. Kairi, S. Abu Bakar, B. Vigolo, A. R. Mohamed, J. Mater. Chem. A, 6 (31), 15010-15026 (2018)]. The efficiency of this process is very low, and graphene flakes are usually present with the addition of larger graphite pieces.

For this reason, alternative techniques for the production of graphene flakes have been developed, such as, for example, epitaxial growth by chemical vapor deposition [A. S. Plaut, U. Wurstbauer, S. Wang, A. L. Levy, L. F. dos Santos, L. Wang, L. N. Pfeiffer, K. Watanabe, T. Taniguchi, C R Dean, J. Hone, A. Pinczuk, J M Garcia, Carbon, 114, 579-584 (2017)]. However, such a method requires complex, relatively expensive equipment, careful control of deposition parameters and energy-intensive production processes.

Methods for obtaining graphene by electrolytic exfoliation are known in the art.

International patent application No. WO 2015131933A1 discloses a method for obtaining graphene by thermal treatment of expanded graphite using microwaves. In the first step, expanded graphite is subjected to thermal treatment, then a suspension of the material obtained in dissolved imidazolium salts is formed, following which expanded graphite is exfoliated to graphene flakes in a liquid by microwave irradiation.

U.S. Pat. No. US8858776 B2 discloses a method for producing graphene flakes comprising electrochemical exfoliation of a graphite material, wherein the electrolyte is an anionic surfactant selected from the group consisting of alkylsulfonate, sodium alkane sulfonate, sodium benzenesulfonate, sodium dodecylbenzenesulfonate, ammonium lauryl sulfate, potassium lauryl sulfate, sulfate sodium salt, sodium dodecyl sulfate, sodium lauryl sulfate, sodium pareth sulfate, dioctyl sodium sulfosuccinate, perfluorobutanesulfonic acid, perfluorooctanesulfonic acid, perfluorononanoic acid, perfluorooctanoic acid, sodium palmitate, and sodium stearate. The exfoliated graphene flakes are collected on a filter, washed, filtered off and dried.

Patent PL/EP 2791057B1 discloses a method for producing expanded hexagonal layered minerals with the use of electrochemical treatment. More broadly, the invention relates to a method for producing expanded hexagonal layered minerals (so-called HLMs) and derivatives thereof with the use of electrochemical treatment. One such HLM mineral is graphite. HLM material is immersed in a suspension formed by a mixture of expanded HLM rock, metal salt and organic solvent, and then electrochemical treatment of the rock is performed by connecting the rock to at least one electrode and carrying out electrolysis in a suspension using at least one additional electrode. The electrolyte is lithium perchlorate in propylene carbonate.

U.S. patent application US 2018/0179648 A1 discloses a method for extracting graphite ore, which may be a raw material for producing graphene by an electrolytic method, wherein the description of the invention provides no specific electrochemical method or example of the use of such a method.

Another U.S. patent application US20130001089 A1 describes an electrolytic method for producing graphene flakes, wherein the solution used in electrolysis may be an acid, a surfactant, a salt or an oxidizing agent, or a combination thereof. Specifically, the description of the invention indicates that the surfactant is an anionic surfactant such as sodium alkane sulfonate, sodium benzenesulfonate, sodium dodecylbenzenesulfonate, ammonium/sodium lauryl sulfate, or perfluorooctanoic acid or sodium palmitate, and the salt may be a buffer and non-buffer salt such as sodium hydrogen phosphate, potassium dihydrogen phosphate, sodium acetate, borax, or combinations thereof.

International patent application WO2013132261A1 discloses a method for producing graphene and graphite nanoplatelet structures with a thickness of less than 100 nm in an electrochemical cell, the cell comprising: a positive graphite electrode (containing highly ordered pyrolytic graphite, natural graphite or synthetic graphite); a negative electrode, which may be graphite or made of other conductive material; and an ionic electrolyte in a solvent in which cations are organic (alkylammonium) ions and metal ions (iron, tin or lithium). Moreover, the positive electrode may be additionally pretreated prior to use in the method of the invention. However, no specific embodiments have been disclosed for the method implemented with the use of natural graphite as an electrode or methods for treating such an electrode.

Prior art documents, including the solutions described above, disclose no methods for producing graphene flakes directly from mineral graphite.

The object of the present invention is to provide a method for producing graphene flakes directly from mineral graphite by electrochemical defoliation (exfoliation) without the need to subject it to pretreatment.

### SUMMARY OF INVENTION

The object of the invention is a method for producing graphene flakes by an electrochemical exfoliation method, where electrodes (anode and cathode) together with electrolyte constitute an electrochemical circuit with current flowing through it, wherein the anode is mineral graphite, the cathode is mineral graphite or other conductive material, and the electrolyte is a solution containing sulfur salts (sulfates) and, optionally, compounds adjusting an electrolyte pH. The electrodes are partially immersed in the electrolyte and electrolysis is carried out, during which graphite particles detach from the electrodes to release graphene flakes into the electrolyte solution, and then the graphene flakes are recovered from the electrolyte solution by filtration, the precipitate is washed with distilled water and dried, following which the precipitate is taken up in DMF and the suspension is subjected to ultrasound at a frequency of 30 kHz for a period of 15 to 30 minutes. The precipitate is then centrifuged and graphene is recovered from the supernatant thus obtained by evaporating the suspension to dryness, drying (at elevated temperature) or freeze-drying.

Preferably, in the method of the invention, the electrolysis is carried out in two steps, where in the first step the electrodes are activated by applying 2 V DC for a period of 5 minutes, then in the second step a DC voltage is increased to 10-15 V and electrolysis is carried out for a period of 5 to 120 minutes.

In the method according to the invention, a solution of ammonium sulfate or ammonium persulfate or a mixture thereof in a 99:1 to 1:99 weight ratio is used as the electrolyte. According to the invention, the electrolyte may also be an acidic solution of ammonium sulfate and/or ammonium persulfate, which is obtained by adding a suitable amount of sulfuric acid to the solution of ammonium sulfates to obtain an electrolyte pH of 1-3, or alternatively, the electrolyte may be an alkaline solution of ammonium sulfate, which is obtained by adding a suitable amount of ammonia water to the solution of ammonium sulfates until an electrolyte pH of 8-10 is obtained.

According to the method of the present invention, the anode may be mineral graphite in the form of a rod or a plate or a graphite material containing more than 30% by weight of mineral graphite.

Preferably, in the method according to the invention, the cathode may also be mineral graphite in the form of a rod or plate, or a metal rod or metal mesh made of metal insoluble in cold sulfuric acid, such as platinum, silver, titanium or nickel.

Preferably, in the method according to the invention, the glass vessel was placed in an ice bath to lower the electrolyte temperature during the process to 4-8° C.

### BRIEF DESCRIPTION OF DRAWINGS

The object of the invention is illustrated in the drawings, in which:

FIG. 1 shows a diagram of the method according to the invention;

FIG. 2 shows an X-ray diffraction pattern of graphene flakes produced by the method according to Example 1;

FIG. 3 shows a TEM image of graphene flakes produced by the method according to Example 1;

FIG. 4 shows a Raman spectrum for graphene flakes produced by the method according to Example 1.

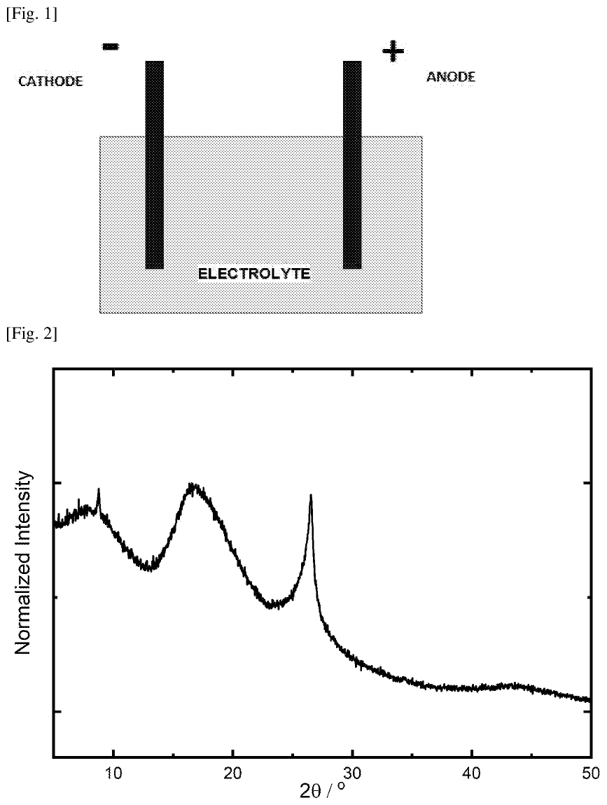

### DESCRIPTION OF EMBODIMENTS

The present invention is presented in more detail in embodiments which do not limit its scope.

### EXAMPLES

A graphite rod (graphite content >95%) with dimensions of 1.3×0.6×7.2 cm (ANODE) and a graphite rod with dimensions of 0.6×3×10 cm (CATHODE) with attached electrical wires (copper wire) were immersed to ¾ of their height in a glass vessel filled with an electrolyte solution, prepared by dissolving 2.4 g ammonium sulfate (NH₄)₂SO₄ in 200 cm³ distilled water, with an electrolyte pH of 6.5. The glass vessel was placed in an ice bath to lower the electrolyte temperature during the process to 4-8° C.

To activate the electrodes, 2 V DC was applied to the electrodes for 5 minutes, a positive voltage to the anode and a negative voltage to the cathode, respectively.

After 5 minutes, a DC voltage was increased to 10 V and a proper process of graphite electrolytic exfoliation was carried out for 120 minutes.

The graphene flakes detaching from the cathode formed a suspension in the electrolyte solution. After the process had ended, the electrodes were removed from the vessel and the graphene flake suspension from the vessel was filtered through analytical filter paper to separate the graphene flakes from the electrolyte solution. The precipitate was washed with portions of distilled water of approx. 250 cm³ (until a positive reaction of sulfate ions with barium ions ended—analytical control, a positive symptom is the lack of precipitate). The precipitate was then dried at a temperature of 60° C. The dry precipitate was taken up in DMF and the suspension was subjected to ultrasound at a frequency of 30 kHz for a period of 15 to 30 minutes. Subsequently, the precipitate was centrifuged in a centrifuge at 2,500 rpm for 15-30 minutes. The centrifuged precipitate was discarded and the supernatant obtained after centrifugation was used to obtain dry graphene by evaporating the suspension to dryness—drying (at elevated temperature until a graphene layer was obtained) or freeze-drying (graphene powder).

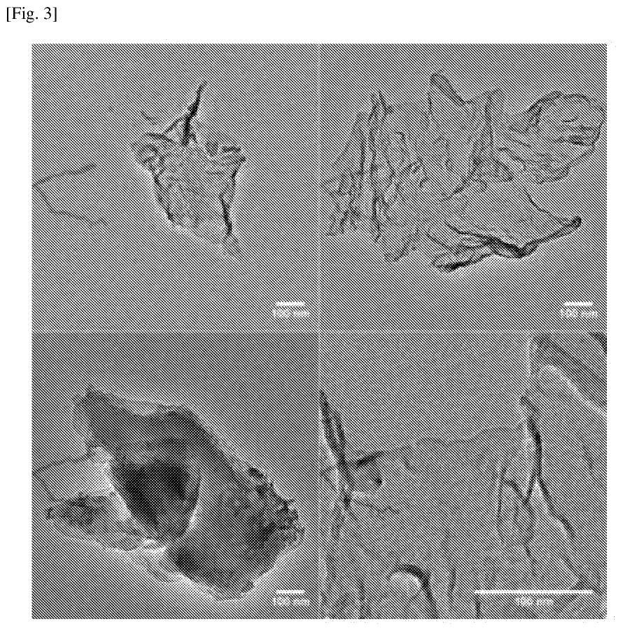

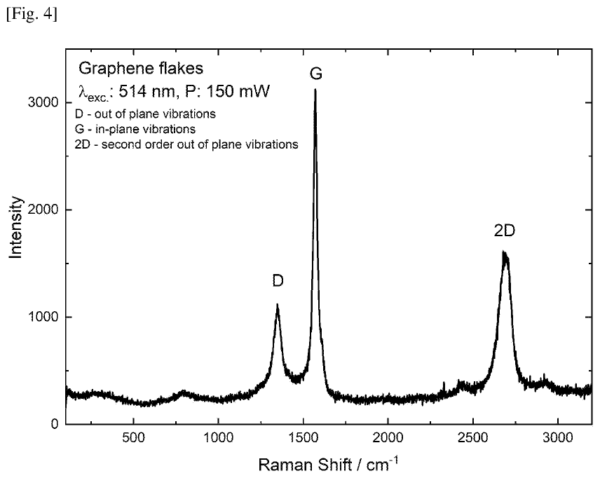

The graphene flakes thus obtained were subjected to physicochemical tests using structural X-ray (FIG. 2), transmission electron microscopy (FIG. 3) and Raman spectroscopy (FIG. 4). Test results show that the resulting product is characterized by a high content of graphene (over 90%) consisting of single or several flake layers with sizes between 300 nm and 1 μm.

### Example 2

The process of graphene electrochemical exfoliation was performed analogously to Example 1, with graphite foil with dimensions of 0.2×2×10 cm (ANODE) and a graphite rod with dimensions of ∅0.6×10 cm (CATHODE) immersed in electrolyte with pH=6.5 being used as electrodes. The electrolyte is a mixture of aqueous solutions of 0.1 M ammonium sulfate and 0.1 M ammonium persulfate in a 1:1 volume ratio. Other electrochemical process conditions were used as described in Example 1.

### Example 3

The process of graphene electrochemical exfoliation was performed analogously to Example 1, with graphite foil with dimensions of 0.2×2×10 cm (ANODE) and a graphite rod with dimensions of ∅0.6×10 cm (CATHODE) immersed in electrolyte with pH=3 being used as electrodes. The electrolyte is a mixture of aqueous solutions of 0.1 M ammonium sulfate, 0.1 M ammonium persulfate and 2M H₂SO₄ in a 100:100:1 volume ratio. Other process conditions were used as described in Example 1.

### Example 4

The process of graphene electrochemical exfoliation was performed analogously to Example 1, with graphite foil with dimensions of 0.2×2×10 cm (ANODE) and a graphite rod with dimensions of ∅0.6×10 cm (CATHODE) immersed in electrolyte with pH=10 being used as electrodes. The electrolyte is a mixture of aqueous solutions of 0.1 M ammonium sulfate, 0.1 M ammonium persulfate and 5M ammonia water in a 100:100:1 volume ratio. Other process conditions were used as described in Example 1.

### Example 5

The process of graphene electrochemical exfoliation was performed analogously to Example 1, with graphite foil with dimensions of 0.2×2×10 cm (ANODE) and a silver plate with dimensions of 0.1×0.6×10 cm (CATHODE) immersed in electrolyte with pH=6.5 being used as electrodes. The electrolyte is a mixture of aqueous solutions of 0.1 M ammonium sulfate and 0.1 M ammonium persulfate in a 1:1 volume ratio. Other process conditions were used as described in Example 1.

1. A method for producing graphene flakes by electrochemical exfoliation, where electrodes (anode and cathode) together with electrolyte constitute an electrochemical circuit with current flowing through it, characterized in that the electrodes are at least partially immersed in the electrolyte and electrolysis is carried out, during which graphite flakes detach from the electrodes to be released into the electrolyte solution, and then the exfoliated graphene flakes are recovered from the electrolyte solution by filtration, then the precipitate is washed with distilled water and dried, wherein the precipitate is taken up in DMF and the obtained suspension is subjected to ultrasound at a frequency of 30 kHz for a period of 15 to 30 minutes, then the precipitate is centrifuged and graphene is recovered from the supernatant thus obtained by evaporating the suspension to dryness by drying (at elevated temperature until a graphene layer is obtained) and/or freeze-drying (graphene powder).

2. The method according to claim 1, characterized in that the anode is mineral graphite, and the cathode is mineral graphite or other conductive material, and the electrolyte is a solution containing sulfur salts (sulfates and/or persulfates) and, optionally, compounds adjusting an electrolyte pH.

3. The method according to claim 1, characterized in that the electrolysis is carried out in two steps, where in the first step the electrodes are activated by applying 2 V DC for a period of 5 minutes, then in the second step a DC voltage is increased to 10-15V and the electrolysis is carried out for a period of 5 to 120 minutes.

4. The method according to claim 1, characterized in that a solution of 0.1 M ammonium sulfate and 0.1 M ammonium persulfate or a mixture thereof in a 99:1 to 1:99 weight ratio is used as the electrolyte.

5. The method according to claim 1, characterized in that the electrolysis is carried out in the presence of an acidic ammonium sulfate solution with pH of 1 to 3 or in the presence of an alkaline ammonium sulfate solution with pH of 8 to 10.

6. The method according to claim 1, characterized in that the anode is a rod or a plate made of material containing over 30% by weight of mineral graphite.

7. The method according to claim 1, characterized in that the cathode is a graphite rod or a metal rod or metal mesh made of metal insoluble in cold sulfuric acid.

8. The method according to claim 1, characterized in that the electrolyte is placed in ice bath and cooled to the 4-8° C.
